(19) United States
(12) Patent Application Publication
(10) Pub. No.: US 2025/0204537 A1
(43) Pub. Date: Jun. 26, 2025

(54) SYSTEM AND METHOD TO FORM EDIBLE DOUGH BOWLS

(71) Applicant: Robert Vaughn Stoddard, Pendleton, IN (US)

(72) Inventor: Robert Vaughn Stoddard, Pendleton, IN (US)

(21) Appl. No.: 18/390,408

(22) Filed: Dec. 20, 2023

(51) Int. Cl. A21C 11/00

(52) U.S. Cl. CPC A21C 11/006

(57) ABSTRACT

A system having a base, a cavity, and a forming plate forms an edible bowl. The base may include a top portion and a bottom portion. The cavity located at the top portion of the base is configured to receive a portion of an edible food dough. The cavity may have a shape of a tapered bowl. The forming plate engages with the cavity to form a bowl-shaped edible food dough. The dough retains its bowl shape during and after baking and freezing without the presence of a male mold element.

### BACKGROUND OF THE INVENTION

### Field of the Invention

The present invention relates to a system and method to form edible dough bowls.

### Description of the Related Art

Consumers desire to eat food products such as ice-creams, chocolates, etc. in edible food vessels. However, it is difficult to manufacture such edible food vessels. In addition, such edible food vessels may not hold the added ingredients/toppings in an original form prepared by the cook.

Currently available means of preparing edible food vessels require the dough to remain between a female and a male mold during forming and baking because the dough will not otherwise retain its molded shape. See, for example, U.S. Pat. Nos. 4,812,323, 5,223,286,11,382,333, and US Published Application No. 2012/0003363, the disclosures of which are incorporated by reference in their entireties.

Thus, there exists a need for an edible food vessel that is easy to manufacture, does not require the presence of a male mold element through baking the vessel, and may properly hold added ingredients/toppings.

### SUMMARY OF THE INVENTION

The following presents a simplified summary of the present disclosure in a simplified form as a prelude to the more detailed description that is presented herein.

In accordance with embodiments of the invention, there is provided a system having a base. The base may include a top portion and a bottom portion. The system may further include a cavity located at the top portion of the base. The cavity may be configured to receive a portion of an edible food dough. The cavity may have a shape of a tapered bowl. The system may further include a forming plate configured to engage with the cavity to form a bowl-shaped edible food dough.

In some aspects, a shape of the forming plate corresponds to a shape of the cavity. The system may further include a bottom plate disposed at a bottom portion of the cavity. The bottom plate may include one or more cavities. The cavities in the bottom plate may include springs configured to push the bowl-shaped edible food dough out of the cavity. The system may further include a top plate configured to engage with the bottom plate. The top plate may be disposed at the bottom portion of the cavity.

The present disclosure is further directed towards a method to prepare a bowl-shaped edible food dough. The method may include preparing an edible food dough and portioning the edible food dough in a baking cup. The food dough may comprise high protein bread flour for stiffness and reduced leavening in order to better retain its formed shape. The method may further include placing the baking cup in a cavity located in a base of a system. The cavity may be located at the top portion of the base. The method may further include engaging a forming plate with the cavity to form bowl shaped edible food dough.

The method may further include disengaging the forming plate with the cavity and removing the baking cup with the bowl-shaped edible food dough from the cavity. The method may further include baking the bowl-shaped edible food dough in the baking cup, without a male mold element, and freezing the bowl-shaped edible food dough.

The present disclosure discloses a system and method that facilitates preparation of bowl-shaped edible food dough that may hold the additional toppings properly. In addition, the system and method facilitate easy and convenient manufacturing of the bowl-shaped edible food dough.

These and other features, aspects, and advantages of the present invention will become better understood with reference to the following description and appended claims.

### BRIEF DESCRIPTION OF THE DRAWINGS

Illustrative embodiments of the present invention are described herein with reference to

the accompanying drawings, in which:

FIG. 1 is an exploded view of a system for forming edible dough bowls in accordance with the present disclosure.

FIG. 2 is a flow chart depicting a method to form edible dough bowls in accordance with the present disclosure.

FIG. 3 depicts a schematic view of a process to edible dough bowls in accordance with the present disclosure.

### DETAILED DESCRIPTION OF INVENTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

Reference will now be made in detail to the present preferred embodiments of the invention, examples of which are illustrated in the accompanying drawings. Wherever possible, the same reference numerals are used in the drawings and the description to refer to the same or like parts.

A non-limiting example of a dough suitable for preparation of the vessels disclosed herein may include about 2 parts by weight bread flour per 1 part by weight salted butter; about 4 parts by weight granulated sugar per 1 part whole liquid eggs; about 10 parts by weight whole liquid eggs per 1 part by weight salt; about 10 parts by weight salt per 1 part by weight vanilla; about 40 parts by weight salt per 1 part by weight sugar; about 3 parts by weight butter per 1 part by weight eggs; and about 30 parts by weight butter per 1 part by weight of salt. The dough may be prepared by creaming butter and sugar together; adding eggs and vanilla and mixing; and adding salt and flour and mixing again.

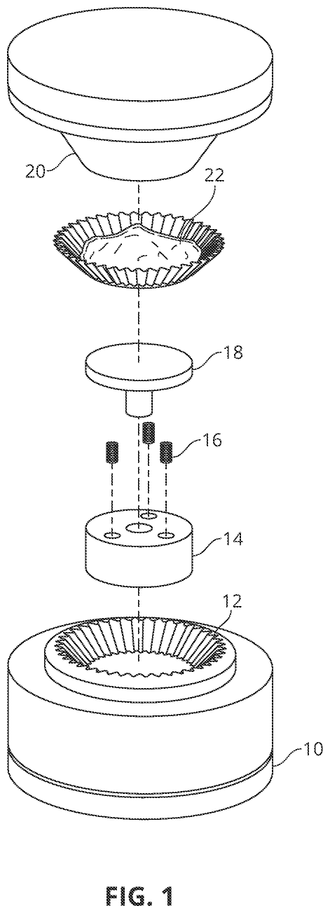

FIG. 1 depicts an exploded view of a system for forming cookie dough bowls in accordance with an embodiment of the present disclosure. The system may include a lower form base 10 having a top surface/portion and a bottom surface/portion (opposite to the top surface/portion). The base 10 may have a cylindrical body. In some aspects, the base 10 may include a base's ridged cavity 12 (or cavity 12) at the top portion of the base 10. In some aspects, the cavity 12 (or recess) may be disposed at a center portion of the top portion of the base 10. In further aspects, the cavity 12 may be shapes as a bowl. In an exemplary aspect, the cavity 12 may have a shape of a tapered bowl. Stated another way, a diameter of a top portion of the cavity 12 may be greater than a diameter of the bottom portion of the cavity 12. In some aspects, the cavity 12 may act as a mold to form the cookie dough bowls.

In some aspects, the system may include a ridged cavity bottom plate 14 that may be placed at the bottom portion of the cavity 12. In some aspects, the bottom plate 14 may have a cylindrical body that may fit at the bottom portion of the cavity 12. In an exemplary embodiment, a diameter of the bottom plate 14 may be equivalent to the diameter of the bottom portion of the cavity 12.

The bottom plate 14 may include a top surface and a bottom surface. In some aspects, the bottom plate 14 may include one or more cavities/recesses at the top surface of the bottom plate 14. In an exemplary aspect, the cavities at the top surface of the bottom plate 14 may include a first cavity at a center of the top surface of the bottom plate 14 and a set of second cavities (or “second cavities”) that may be disposed around the first cavity. The second cavities may be disposed at a periphery of the top surface of the bottom plate 14. In some aspects, the bottom plate 14 may include three second cavities. The second cavities may be configured to receive springs 16, and the first cavity may be configured to receive a portion of a top plate 18. In some aspects, the springs 16 may be located between the top plate 18 and the bottom plate 14. The details of the top plate 18 are described below.

In some aspects, the top plate 18 may be configured to engage with the bottom plate 14. The top plate 18 may include a top portion and a bottom portion. The top portion of the top plate 18 may be a circular plate and the bottom portion may have a protrusion (e.g., a straight/linear cylindrical pipe or pin) that may extend from the circular plate. In some aspects, the protrusion may extend from a bottom surface of the circular plate. In some aspects, the protrusion may extend from a center portion of the circular plate. The protrusion may be configured to be inserted into the first cavity of the bottom plate 14. Thus, the top plate 18 may be removably attached to the bottom plate 14. When the protrusion may be inserted into the first cavity, the top plate 18 may be attached to the bottom plate 14. When the protrusion is out of the first cavity, the top plate 18 may be detached from the bottom plate 14.

In some aspects, a diameter of the top plate 18 (e.g., the circular plate) may be equivalent to the diameter of the bottom plate 14. In some aspects, a diameter of the protrusion may be less than the diameter of the circular plate. The bottom plate 14 and the top plate 18 may be configured to be positioned in the bottom portion of the cavity 12.

In some aspects, the top plate 18 may be configured to hold a specific formulated dough 22 (e.g., cookie dough or other edible food dough) in a cup container on a top surface of the circular plate. Stated another way, the cavity 12 may be configured to receive/hold a portion of the edible food dough. The cup container may be made of any material. Preferably, the container has fluted walls at a specified angle. For example, the cup container may be a NOVACART® Optima 680685, a free-standing paper baking mold made of triple layer cardboard comprising uncoated, bleached pure cellulose. An inner layer of the Optima 680685 cup container is laminated with polyethylene terephthalate (PET) for easy release. The cup generally has about 42 flutes (counted either from outward bend to outward bend or inward bend to inward bend) with a base diameter of about 90 mm, a top diameter of about 100 mm, and a height of about 30 mm. The angles of the flutes are believed to contribute a surprisingly high amount of strength to the bowl circumferential sidewall such that it remains upright from forming through baking. The sidewall may have a thickness of about 1/16″ to about ⅜″, such as about 3/16″.

In some aspects, the system may include a forming plate 20 that may be configured to engage with the cavity 12. The forming plate 20 may include a first portion and a second portion. The first portion may be a circular plate and the second portion may be a protrusion that may extend from a bottom surface of the circular plate (e.g., from a center portion of the circular plate). In some aspects, a diameter of the forming plate 20 (e.g., the circular plate of the forming plate 20) may be greater than the diameter of the top plate 18. In some aspects, the protrusion may be a tapered body that may be configured to create a cookie dough that may have a bowl shape. The shape of the protrusion may correspond with the shape of the cavity 12. In some aspects, a size (e.g., a diameter) of the cavity 12 may be greater than a size (e.g., a diameter) of the protrusion of the forming plate 20. The bowl-shaped cookie dough may have high ridges at a periphery to allow a user to add/hold additional ingredient/topping in the bowl-shaped cookie dough.

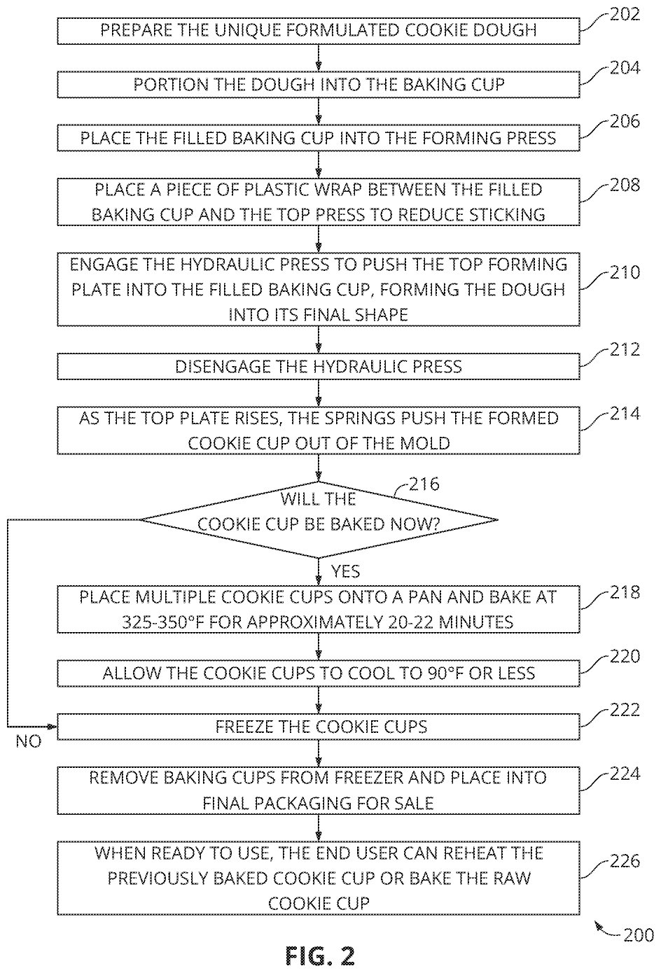

FIG. 2 depicts a method 200 to form cookie dough bowls in accordance with the present disclosure. At step 202, the method 200 may include preparing a unique formulated cookie dough that may facilitate preparation of bowl shaped cookie dough. At step 204, the method 200 may include portioning the dough into a baking cup. In an exemplary embodiment, 3 ounces of dough may be placed in the baking cup.

At step 206, the method 200 may include placing the filled baking cup into a forming press (as described in conjunction with FIG. 1). For example, the filled baking cup may be placed on the top plate 18 (in the cavity 12), as depicted in conjunction with FIG. 1.

At step 208, the method 200 may include placing a piece of a plastic wrap between the filled baking cup and the top press to reduce sticking. In an exemplary aspect, the plastic wrap may be disposed between the filled baking cup and the forming plate 20 shown in FIG. 1.

At step 210, the method 200 may include engaging the hydraulic press to push the forming plate 20 into the filled baking cup, forming the dough in its final shape (e.g., bowl-shaped dough). At step 212, the method 200 may include disengaging the hydraulic press to disengage the forming plate 20 from the cavity 12. At step 214, the method 200 may include pushing the formed cookie cup out of the mold (or the cavity 12) by the spring 16, as the top plate 18 rises. The food vessels disclosed herein do not require the presence of a male mold element to retain the vessel shape beyond method step 212.

At step 216, the method 200 may include determining whether the cookie cup is to be baked. When the cookie cup is not to be baked, the method 200 may move to step 222. At step 222, the method 200 may include freezing the cookie cups within the baking cups. When the cookie cups are frozen, the method 200 may move to step 224. At step 224, the method 200 may include removing the baking cups from the freezer and placing the final packaging for sale.

When the cookie cup is to be baked, the method 200 may move to step 218. At step 218, the method 200 may include placing multiple cookie cup-containing baking cups onto a pan and heat the cookie cups at about 300-350 degrees Fahrenheit for about 20-25 minutes. At step 220, the method 200 may include allowing the cookie cups to cool to 90 degrees Fahrenheit or less. The method 200 may then move to steps 222, 224, and 226.

At step 226, the method 200 may include baking the raw cookie cup or reheating previously baked cookie by an end user when it is ready to use.

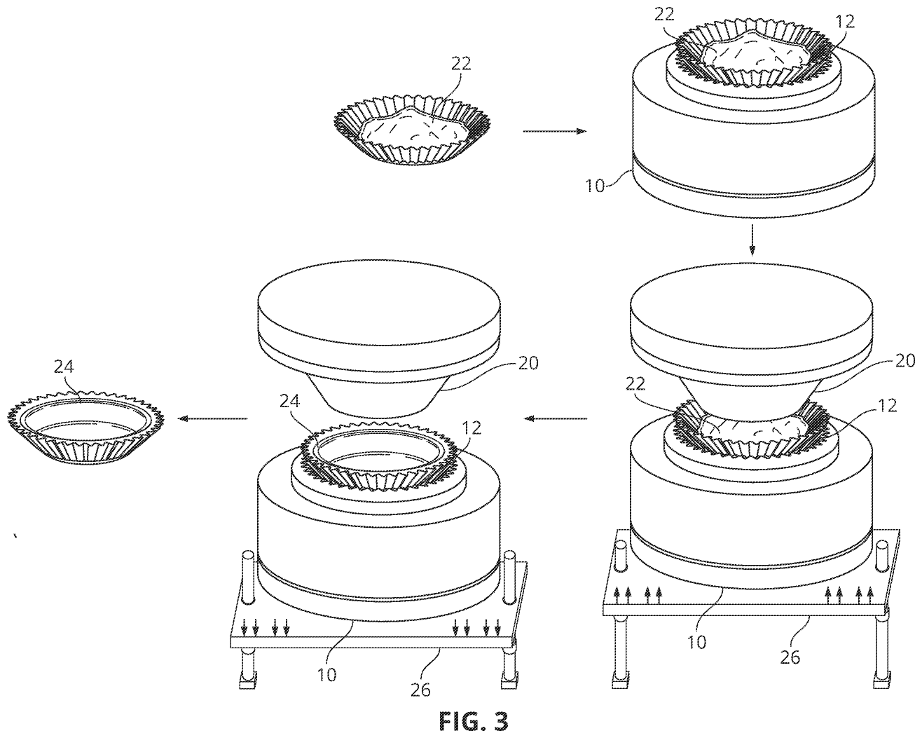

FIG. 3 depicts a schematic view of a process to form cookie dough bowls in accordance with the present disclosure. The process may include preparing and portioning the cookie dough 22 in a baking cup. The baking cup with cookie dough may be placed in the cavity 12 (e.g., on the top plate 18) associated with the base 10. When the baking cup with the cookie dough is placed in the cavity 12, the forming plate 20 may be pressed downwards (e.g., towards the cavity 12) to create a bowl shaped dough from the cookie dough placed in the baking cup. In some aspects, a plastic sheet may be placed between the forming plate 20 and the cookie dough 22 to prevent sticking. When the forming plate 20 may be pressed downwards, the springs 16 may compress. In some aspects, a hydraulic plate 26 may be engaged to push the forming plate 20 into the filled baking cup.

Next, the forming plate 20 may be pulled upwards or away from the cavity 12. When the forming plate 20 may be pulled upwards, the springs 16 may decompress and push the baking cup with bowl shaped cookie dough 24 out of the cavity 12. The bowl shaped cookie dough 24 may be processed without a male mold element, based on user requirements. The processing may include baking, freezing, etc.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

The claimed invention is:

1. A system comprising:
a base having a top portion and a bottom portion;
a cavity located at the top portion of the base, wherein the cavity is configured to receive a portion of an edible food dough, and wherein the cavity has a shape of a tapered bowl; and
a forming plate configured to engage with the cavity to form a bowl-shaped edible food dough.

2. The system of claim 1, wherein a shape of the forming plate corresponds to a shape of the cavity.

3. The system of claim 1, further comprising a bottom plate disposed at the bottom portion of the cavity, wherein the bottom plate comprises one or more cavities.

4. The system of claim 3, wherein the one or more cavities comprise springs configured to push the bowl-shaped edible food dough out of the cavity.

5. The system of claim 3, further comprising a top plate configured to engage with the bottom plate, wherein the top plate is disposed at the bottom portion of the cavity.

6. A method to prepare a bowl shaped edible food dough, the method comprising:
preparing an edible food dough;
portioning the edible food dough in a baking cup;
placing the baking cup in a cavity located in a base of a system, wherein the cavity is located at a top portion of the base, and wherein the cavity has a shape of a tapered bowl; and
engaging a forming plate with the cavity to form a bowl-shaped edible food dough.

7. The method of claim 6, further comprising disengaging the forming plate from the cavity.

8. The method of claim 6, further comprising removing the bowl-shaped edible food dough from the cavity.

9. The method of claim 6, further comprising baking the bowl-shaped edible food dough in the baking cup.

10. The method of claim 9, wherein no male mold element is present during the baking.

11. The method of claim 6, further comprising freezing the bowl-shaped edible food dough.

12. The method of claim 11, wherein no male mold element is present during the freezing.
